(19) United States
(12) Patent Application Publication
(10) Pub. No.: US 2020/0013303 A1
(43) Pub. Date: Jan. 9, 2020

(54) Internet of Things

(71) Applicants: Robert CV. Chen, Cupertino, CA (US); Tiffany YW. Chen, Cupertino, CA (US)

(72) Inventors: Robert CV. Chen, Cupertino, CA (US); Tiffany YW. Chen, Cupertino, CA (US)

(21) Appl. No.: 15/682,889

(22) Filed: Aug. 22, 2017

(51) Int. Cl. G09B 5/06; G09B 21/00; A47G 21/02; A47D 15/00; A47D 1/00; B60N 3/00; A47G 19/22; A47G 23/06; B62B 9/26

(52) U.S. Cl. CPC G09B 5/065; G09B 21/004; G09B 21/009; A47G 21/02; A47D 15/00; A47D 1/0085; B62B 7/145; A47G 19/2227; A47G 23/06; B62B 9/26; A47G 2019/2244; A47G 2019/2238; A47G 2023/0658; B60N 3/002

(57) ABSTRACT

An internet of things interactive learning device, system and method for a child comprises a talking table set including a display screen, a speaker, interactive handle buttons, a multimedia processor with memory and drivers for all components thereof in communication therewith. The multimedia processor is configured to record and play back a parent's message and a child's voice as speech and song on-demand and to display on the screen a parent's video and a recording of the child's eating habits. The disclosure also includes eating and drinking utensils comprising interactive handle buttons and circuitry configured to talk wirelessly to the talking table set per real time input from the child and the parent. An internet subscription service module provides multimedia content including licensed songs, stories and music to the talking table set. A real-time language translator broadcasts the message and voice into as many as 30 spoken languages.

### BACKGROUND OF THE INVENTION

Meal time in a family is a very important part of the learning and development of a young mind. Studies have shown that meal time in a family not only increases a child's feeling of security and love but also is a prime time for learning from parents, siblings, family members and friends. Some of the benefits of spending meal time together include better academic performance, higher self-esteem, greater sense of resilience, lower risk of substance abuse, lower risk of teen pregnancy, lower risk of depression, lower likelihood of developing eating disorders and lower rates of obesity.

However, finding a time to get everyone together is a challenge and younger children will often need to eat or snack while a parent or a caregiver is busy cleaning up the kitchen, doing laundry, and multitasking caregiving. Many parents turn on the TV for a child during meals. However, though this allows for a parent or caregiver to do other things without directly attending to a child's needs, researchers have found that meals eaten in front of a TV do not carry the same mental health benefits as those eaten with family Certainly it is fine to occasionally to watch a special program on TV while eating a meal at home but as a lifestyle not the most beneficial use of a child's younger years.

Children benefit from interactive conversations. A simple, “what did you do today?” results in fun answers about what the child saw on a walk or did during playtime. Asking children to describe their favorite color, game, food, cartoon or toy also sparks interest and generates engaged responses. A parent might ask, “what can your favorite toy or cartoon character do that you'd like to do someday?”

Additionally, images and photos are great conversations starters. If a parent has a photo that can get messy, bringing it to the dinner table and ask a child to describe what he or she sees. If it's a family photo, the child may ask who's in the picture and what they're doing. This often leads to a fun discussion about different family members and their lives Family interviews are additionally a fun way of helping a child to better know family members. Such interactions do not require any right answer or even a best answer. For instance, give a child an opportunity to meet a public figure present or through history as a way of learning and interacting.

One-line conversation starters are also great for young children. For instance, “if you could be an animal, what would you want to be, and why?” is a wonderful way to get a child learning and involved in a lively exchange. Another one liner is, “if you had three wishes, what would they be?” is also bound to create some interesting and engaging responses.

There has therefore been a long unsatisfied demand in the market place for an intelligent device, system and method of entertaining and educating young children during meal and snack times.

### SUMMARY OF THE INVENTION

An ‘internet of things,’ includes an interactive learning device, system and method for a child, specifically a talking table set including a display screen, a speaker, a plurality of interactive handle buttons, a multimedia processor with memory and drivers for all components thereof in communication therewith. The multimedia processor is configured to record and play back a parent's message and a child's voice as speech and song on-demand and to display on the screen a parent's video and a recording of the child's eating habits. The disclosure also includes eating and drinking utensils comprising interactive handle buttons and circuitry configured to talk wirelessly to the talking table set per real time input from the child and the parent. An internet subscription service module provides multimedia content including licensed songs, stories and music to the talking table set. A real-time language translator broadcasts the message and voice into another spoken language.

The internet of things' interactive learning device for a child is adapted to mount to a walking stroller, to a jogging stroller a high chair and adapted to mount to a child's car seat. The 3 handle buttons correspond to a first choice, a second choice and a third choice in that order from a top button, a middle button and a bottom button. The talking table set is a sippy cup comprising a pair of left and right handles wherein each handle includes a plurality of the handle buttons. The talking table set further comprises an external input/output port such as a USB (universal serial bus) port for a wired communication and power supply therefore. A disclosed wireless phone application enables the parent to manage the multimedia processor and a content delivered to the child therewith. The talking table set further includes two handholds each comprising a cutout configured to receive an eating utensil. The talking table set is configured substantially in the shape of a plate and a tray having a plurality of handholds and multiple separated food compartments.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1A is a front elevational view of a sippy cup component of the intelligent talking table set in accordance with an embodiment of the present disclosure.

FIG. 1B is a side elevational view of a sippy cup component of the intelligent talking table set in accordance with an embodiment of the present disclosure.

FIG. 1C is a top elevational view of a sippy cup component of the intelligent talking table set in accordance with an embodiment of the present disclosure.

FIG. 2A is a back elevational view of a sippy cup component of the intelligent talking table set in accordance with an embodiment of the present disclosure.

FIG. 2B is a side elevational view of a sippy cup component of the intelligent talking table set in accordance with an embodiment of the present disclosure.

FIG. 2C is a bottom elevational view of a sippy cup component of the intelligent talking table set in accordance with an embodiment of the present disclosure.

FIG. 3A is a front side perspective view of a sippy cup component of the intelligent talking table set in accordance with an embodiment of the present disclosure.

FIG. 3B is a backside perspective view of a sippy cup component of the intelligent talking table set in accordance with an embodiment of the present disclosure.

FIG. 4 is a cut away block diagram of the sippy cup showing respective internal and external electronic and electric components in accordance with an embodiment of the present disclosure.

FIG. 5A depicts a front elevational view of an intelligent and talking spork eating utensil in accordance with an embodiment of the present disclosure.

FIG. 5B depicts a left side elevational view of an intelligent and talking spork eating utensil in accordance with an embodiment of the present disclosure.

FIG. 5C depicts a right side elevational view and a perspective view of an intelligent and talking spork eating utensil in accordance with an embodiment of the present disclosure.

FIG. 5D depicts a top elevational view of an intelligent and talking spork eating utensil in accordance with an embodiment of the present disclosure.

FIG. 5E depicts a perspective view of an intelligent and talking spork eating utensil in accordance with an embodiment of the present disclosure.

FIG. 6A depicts a top elevational view of an intelligent and talking table set tray in accordance with an embodiment of the present disclosure.

FIG. 6B depicts a front side elevational view of an intelligent and talking table set tray in accordance with an embodiment of the present disclosure.

FIG. 6C depicts a backside elevational view of an intelligent and talking table set tray in accordance with an embodiment of the present disclosure.

FIG. 6D depicts a left side elevational view of an intelligent and talking table set tray in accordance with an embodiment of the present disclosure.

FIG. 6E depicts a right side elevational view of an intelligent and talking table set tray in accordance with an embodiment of the present disclosure.

FIG. 6F depicts a front side cross sectional view taken along B-B of FIG. 6A of an intelligent and talking table set tray in accordance with an embodiment of the present disclosure.

FIG. 6G depicts a cross sectional view taken along A-A of FIG. 6A of an intelligent and talking table set tray in accordance with an embodiment of the present disclosure.

FIG. 7 depicts a top perspective view of an intelligent and talking table set tray including utensil holders and handle buttons in accordance with an embodiment of the present disclosure.

FIG. 8 is a cut away block diagram top view of the intelligent and talking table set tray showing internal electronic components in accordance with an embodiment of the present disclosure.

FIG. 9A depicts a top side elevational view of an intelligent and talking table set plate in accordance with an embodiment of the present disclosure.

FIG. 9B depicts a front side elevational view of an intelligent and talking table set plate in accordance with an embodiment of the present disclosure.

FIG. 9C depicts a back side elevational view of an intelligent and talking table set plate in accordance with an embodiment of the present disclosure.

FIG. 9D depicts a left side elevational view of an intelligent and talking table set plate in accordance with an embodiment of the present disclosure.

FIG. 9E depicts a right side elevational view of an intelligent and talking table set plate in accordance with an embodiment of the present disclosure.

FIG. 9F depicts a cross sectional view taken along A-A of FIG. 9A of the intelligent and talking table set plate in accordance with an embodiment of the present disclosure

FIG. 10 depicts a top perspective view of an intelligent and talking table set plate including utensil holders and handle buttons in accordance with an embodiment of the present disclosure.

FIG. 11 is a cut away block diagram top view of the intelligent and talking table set plate showing internal electronic components in accordance with an embodiment of the present disclosure.

Throughout the description, same reference numbers may be used to identify same or similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘control’ refers to a mechanical depression of a button to make an electronic selection of a choice presented to the user aurally or visually or tactilely. The term ‘interactive’ refers to, inter alia, the display screen and other components which require input from a user and present output in response thereto. The interactive display screen therefore displays video and other visual input/output including a programmable bubble display which is used to communicate with visually impaired users via a braille or a modified braille in real time. Eating habits are defined herein as characteristic ways a child eat food including the selection of some foods over others and the use of utensils and fingers. A sippy cup is a term for a cup which controls the amount of fluid leaving a spout or nipple to a child and otherwise even though upside down will not dispense liquid. A ‘spork’ is a common term denoting a combination utensil providing a shape of a spoon and the tines of a fork in one utensil.

Dimensions detailed herein and in the drawings are intended to be a guide to nominal manufacturing dimensions. The detailed dimensions may vary by plus or minus ten percent taking into account manufacturing restraints and materials for various embodiments as recited, taught and suggested herein. The dimensions therefore are applicable to at least one embodiment but are not meant to be limiting to other embodiments of the disclosure.

Younger children love guessing games. Younger kids (ages 2-7) love guessing games. Give a child an opportunity to “spy” something on the dinner table. Your children might also enjoy our “Can You Remember?” game. Have them close their eyes, and ask them if they can remember what their surroundings looked like (“What color was my shirt? How many dishes are on the table?”).

Games like “Which One?” are great for anyone who likes to play 20 questions. For a more food-oriented guessing game, a child is asked to guess the ingredients in their meals. To make this game even more engaging, one could add a “secret” ingredient to the meal, like vanilla or paprika. This is a fun way to get kids thinking about food and how it's prepared.

Try exploring mystery foods. Take your children to the supermarket and ask them to pick out a fruit or vegetable they've never seen before or never eaten at home. Years ago, my kids picked out a coconut, and we spent a whole afternoon trying to figure out how to open it. After taking hammers and chisels to it, we finally cleared out the street below and hurled it from a third-floor window. You may fare better by googling a new food for ideas about how to prepare it, or by checking epicurious.com for recipe suggestions.

Users might also want to play with color and taste in different ways. Ask your kids to think up a menu in all one color and then help you make it. Or, ask your kids to think up a menu that has all five tastes—bitter, sweet, sour, salty and umami and help you make it.

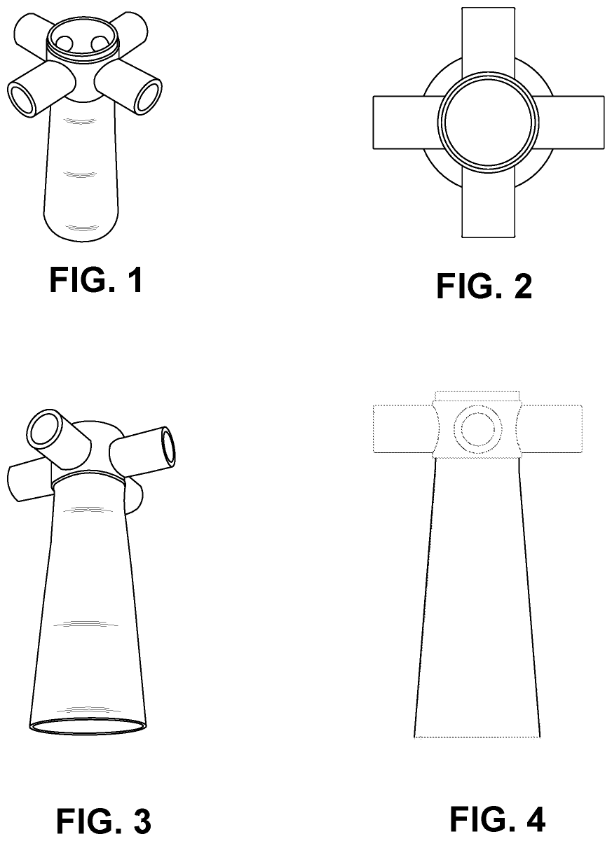

FIGS. 1A, 1B and 1C are respective front, side and top elevational views of a sippy cup component of the intelligent talking table set in accordance with an embodiment of the present disclosure. The views depict the sippy cup 5 components including an electronic display screen 10 that may be touch sensitive, a first interactive button 15, a second interactive button 20 and a third interactive button 25, a first handle 30 and a second handle 35 and a rear fluid indicator window 45.

FIGS. 2A, 2B and 2C are respective back, side and bottom elevational views of a sippy cup component of the intelligent talking table set in accordance with an embodiment of the present disclosure. The views depict the sippy cup 5 components including an electronic display screen 10 that may be touch sensitive, a first interactive button 15, a second interactive button 20 and a third interactive button 25, a first handle 30 and a second handle 35 and a rear fluid indicator window 45.

FIG. 3A and FIG. 3B are a respective front side perspective view and a back-side perspective view of a sippy cup component of the intelligent talking table set in accordance with an embodiment of the present disclosure. The views depict the sippy cup 5 components including an electronic display screen 10 that may be touch sensitive, a first interactive button 15, a second interactive button 20 and a third interactive button 25, a first handle 30 and a second handle 35 and a rear fluid indicator window 45.

FIG. 4 is a cut away block diagram of the sippy cup showing respective internal and external electronic and electric components in accordance with an embodiment of the present disclosure. The depiction includes the components of previous figures but additionally includes a printed circuit board (PCB) and components mounted thereon such as an electronic microprocessor 55, a Bluetooth module 60 and an electronic memory 65. The depiction also includes top handle buttons 70 and side handle buttons 75 on both the left and the right handles. The handle buttons are ergonomic gripping surfaces and are also electronically programmable in place of the selection buttons 15, 20 and 25. A mini USB (universal serial bus) port 80 is also included on the sippy cup for downloading multimedia files into the device memory 65 or for streaming straight into the microprocessor for display on the multimedia screen 10 and speakers (not depicted) or for other electronic processing.

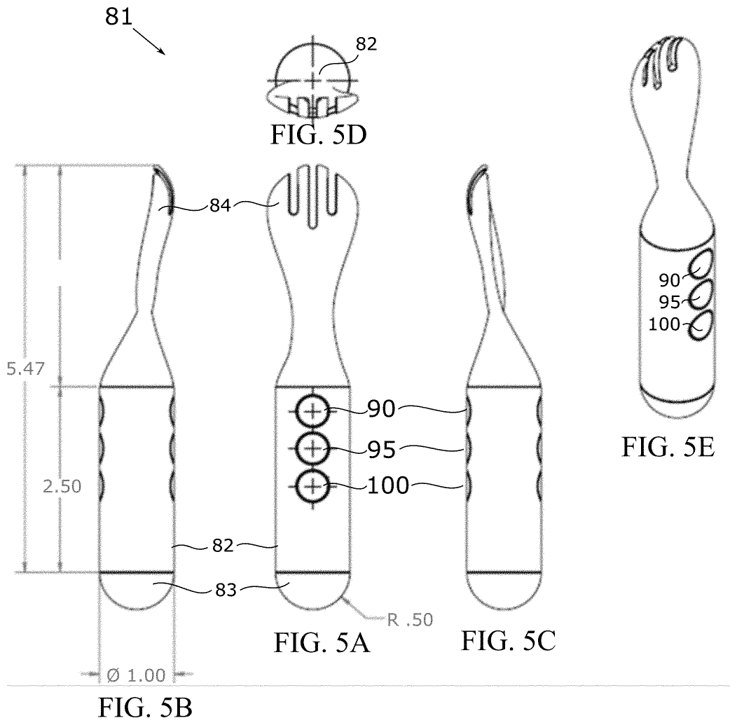

FIGS. 5A, 5B, 5C, 5D and 5E depicts a respective front, both left and right sides and a top elevational view and a perspective view of an intelligent and talking spork eating utensil in accordance with an embodiment of the present disclosure. The spork 81 includes a body 82, a base cap 83, a utensil end 84 resembling both a fork and a spoon utensil. The spork also includes a first handle select button 90, a second handle select button 95 and a third handle select button 100. Logic circuits within the eating utensil include functions to handshake with the talking table set device and base device for a user child to select options to interact with the multimedia presented to the user child.

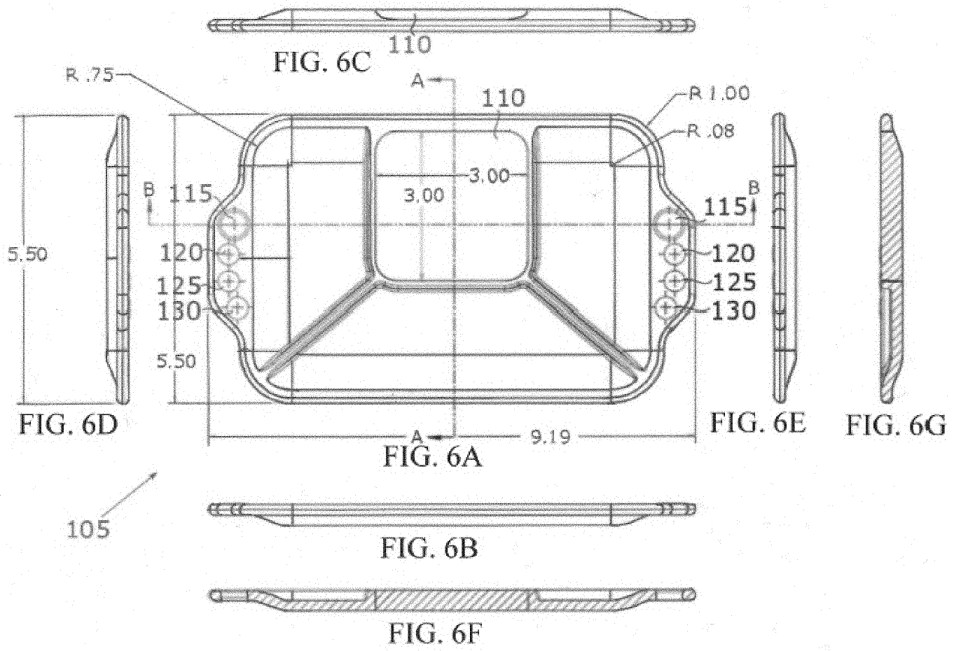

FIGS. 6A, 6B, 6C, 6D, 6E, 6F, and 6G depict a respective top, front side, backside, left side and right side elevational views and a front side cross sectional view and a right-side cross sectional view taken respectively along B-B and A-A of an intelligent and talking table set tray in accordance with an embodiment of the present disclosure. The talking table set tray 105 includes a multimedia screen 110, a utensil holder 115, a first handle select button 120, a second handle select button 125 and a third handle select button 130. Other components same as or similar to components depicted in other figures herein are also depicted.

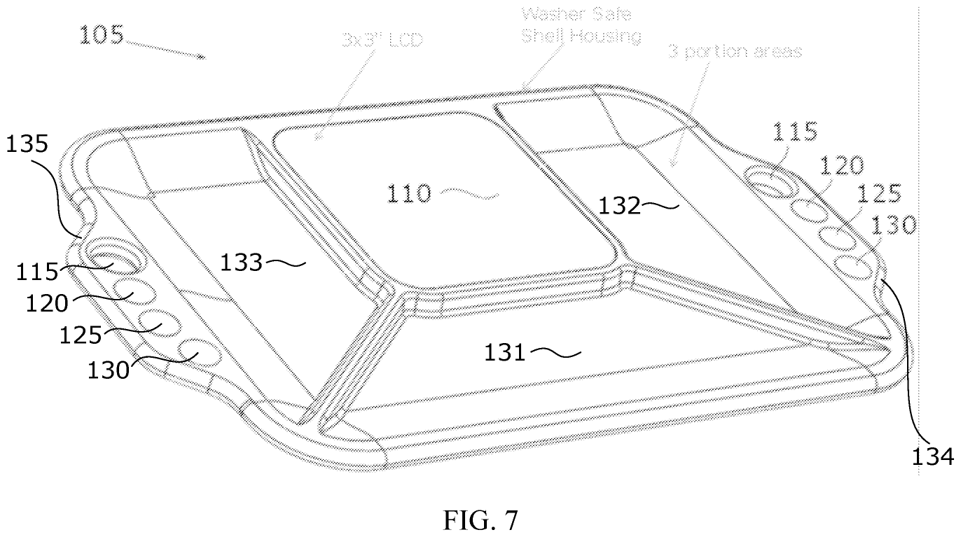

FIG. 7 depicts a top perspective view of an intelligent and talking table set tray including utensil holders and handle buttons in accordance with an embodiment of the present disclosure. The talking table set tray 105 includes a multimedia screen 110, utensil holders 115, first handle select buttons 120, second handle select buttons 125 and third handle select buttons 130. The talking table set tray also includes a first food divided area 131, a second food divided area 132 and a third food divided area 133 and a right handle portion 134 and a left handle portion 135 of the tray.

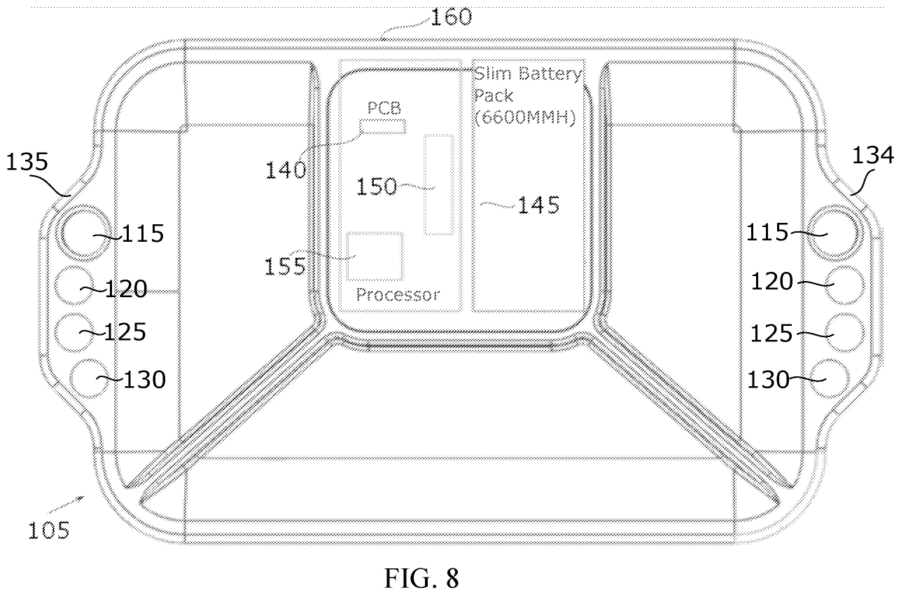

FIG. 8 is a cut away block diagram top view of the intelligent and talking table set tray showing internal electronic components in accordance with an embodiment of the present disclosure. The talking table set tray includes the components of previous figures but additionally includes a printed circuit board (PCB) and components mounted thereon such as an electronic microprocessor 155, a Bluetooth module 140 and an electronic memory 150. Additionally, a slim battery pack 145 supporting the components at 6600 MH (megahertz) is included therein.

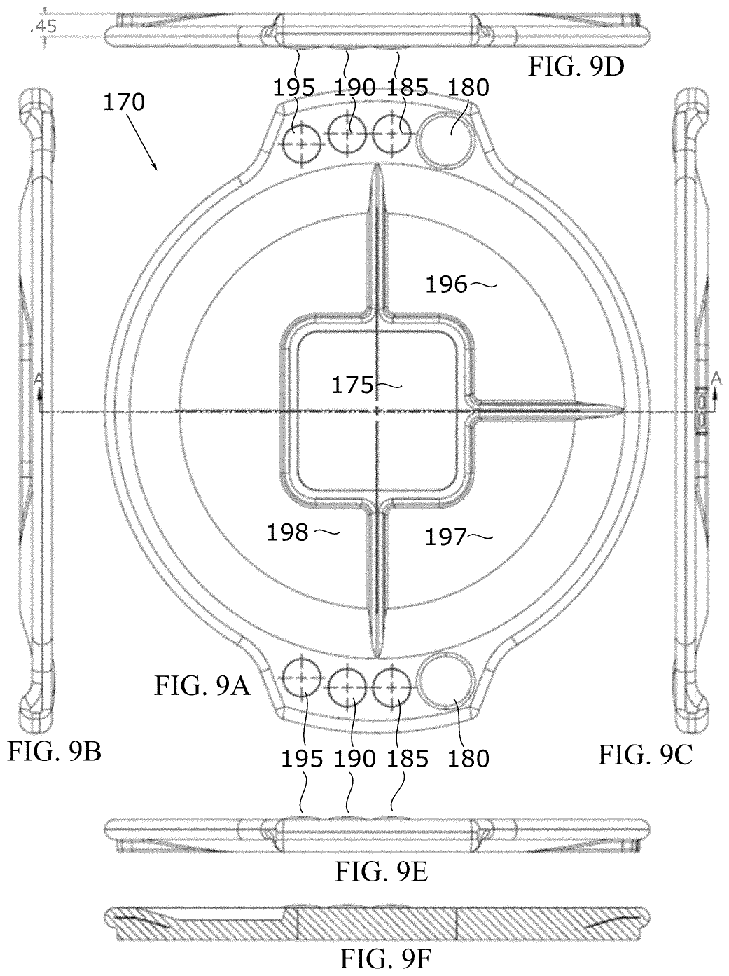

FIGS. 9A, 9B, 9C, 9D, 9E and 9F depicts a respective top, front side, back side, left side, right side elevational views and one cross sectional view taken along A-A of an intelligent and talking table set plate in accordance with an embodiment of the present disclosure. The talking table set plate 170 includes the components of previous figures but additionally includes the multimedia screen 175, utensil holders 180, first handle select buttons 185, second handle select buttons 190 and third handle select buttons 195. The talking table set plate also includes a first food divided area 196, a second food divided area 197 and a third food divided area 198.

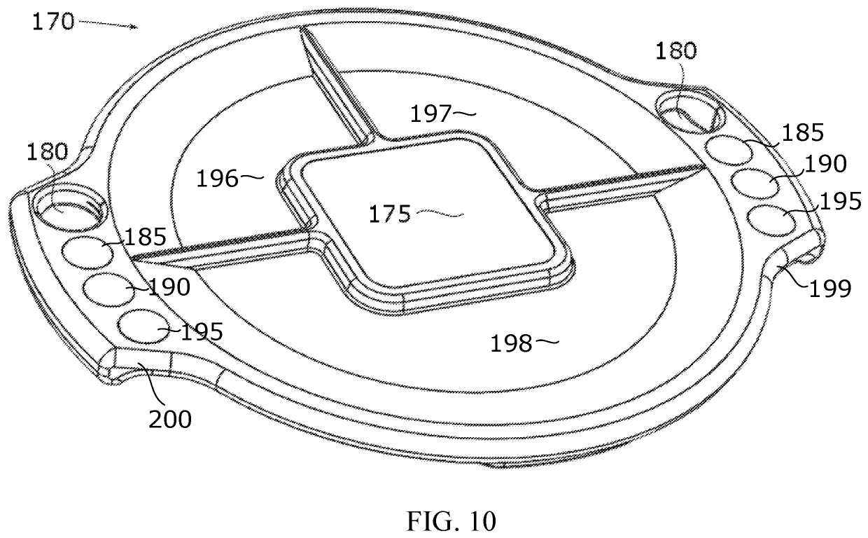

FIG. 10 depicts a top perspective view of an intelligent and talking table set plate including utensil holders and handle buttons in accordance with an embodiment of the present disclosure. The talking table set plate 170 includes the components of previous figures but additionally includes the multimedia screen 175, utensil holders 180, first handle select buttons 185, second handle select buttons 190 and third handle select buttons 195. The talking table set plate also includes a first food divided area 196, a second food divided area 197 and a third food divided area 198. The talking table set plate also includes a right handle portion 199 and a left handle portion 200 for a user such as a child to handle the plate and to control the screen and multimedia associated therewith via movements including depression of the handle buttons 185, 190 and 195.

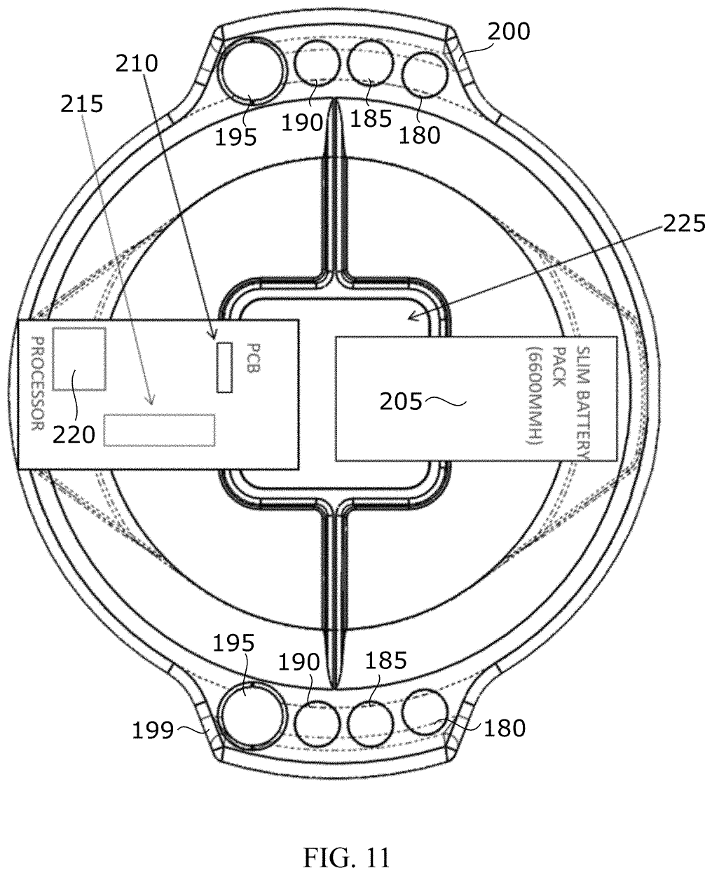

FIG. 11 is a cut away block diagram top view of the intelligent and talking table set plate showing internal electronic components in accordance with an embodiment of the present disclosure. The talking table set tray includes the components of previous figures but additionally includes a printed circuit board (PCB) and components mounted thereon such as an electronic microprocessor 220, a Bluetooth module 210 and an electronic memory 215. Additionally, a slim battery pack 205 supporting the components at 6600 MH (megahertz) is included therein.

The present disclosure is therefore an ‘internet of things’ device, system and method which meets the long felt need in the market for child interaction at meal time. The internet is used for a multimedia option for the child user. The present disclosure also provides electronic means for a parent or caretaker to prerecord video for a child to playback including the ability for a child to record their own eating habits.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An interactive learning device for a child, comprising:
a talking table set comprising an internet of things' interactive display screen, a speaker, a plurality of handle buttons, a multimedia processor with memory and drivers for all components thereof in communication therewith, wherein
the multimedia processor is configured to record and play back a parent's message and a child's voice as speech and song on-demand and to display on the screen a parent's video and a content for the child thereof.

2. The interactive learning device for a child of claim 1, wherein the talking table set is configured to talk aurally to the child, to talk wirelessly to at least one eating and drinking utensil and to talk visually to a child through sign language on the display screen and to talk tactilely to a child via a dynamic bubble braille system presented on the interactive display screen.

3. The interactive learning device for a child of claim 1, wherein the talking table set is adapted to mount to a walking stroller and to a jogging stroller and adapted to mount to a children's high chair and to a child's car seat.

4. The interactive learning device for a child of claim 1, wherein the plurality of handle buttons on the talking table set comprise 3 control buttons corresponding to a first choice, a second choice and a third choice in that order from a top button, a middle button and a bottom button.

5. The interactive learning device for a child of claim 1, wherein the talking table set is a sippy cup comprising a pair of left and right handles wherein each handle includes a plurality of the handle buttons.

6. The interactive learning device for a child of claim 1, further comprising an internet subscription service module in connection with the multimedia processor, the service module configured to provide multimedia content including licensed songs, stories and music to the talking table set.

7. The interactive learning device for a child of claim 1, further comprising a real-time language translator configured to translate and broadcast the message and voice into another spoken language.

8. The interactive learning device for a child of claim 1, wherein the talking table set further comprises an external input/output port such as a USB (universal serial bus) port for a wired communication and power supply there through.

9. The interactive learning device for a child of claim 1, further comprising a wireless phone application configured to enable the parent to manage the multimedia processor and a content delivered to the child therewith.

10. The interactive learning device for a child of claim 1, wherein the talking table set further includes two handholds each comprising a cutout configured to receive an eating utensil.

11. The interactive learning device for a child of claim 1, wherein the talking table set is configured substantially in the shape of a plate and a tray having a plurality of handholds and multiple separated food compartments.

12. An interactive learning method for a child, comprising:
providing a talking table set base comprising a display screen, a speaker, a plurality of interactive handle buttons, a multimedia processor with memory and drivers for all components thereof in communication therewith, wherein
the multimedia processor is configured to record and play back a parent's message and a child's voice as speech and song on-demand and to display on the screen a parent's video and a recording of the child's eating habits; and
providing at least one eating and drinking utensil comprising a plurality of interactive handle buttons and electronic logic configured to talk wirelessly to the talking table set base per real time input from the child and the parent.

13. The interactive learning method for a child of claim 12, further comprising an internet subscription service in connection with the multimedia processor, the service configured to provide multimedia content including licensed songs, stories and music to the talking table set base.

14. The interactive learning method for a child of claim 12, further comprising a real-time language translator configured to translate and broadcast the message and voice into another spoken language.

15. The interactive learning method for a child of claim 12, further comprising a wireless phone application configured to enable the parent to manage the multimedia processor and a content delivered to the child therewith.

16. An interactive learning system for a child, comprising:
a talking table set base comprising a display screen, a speaker, a plurality of interactive handle buttons, a multimedia processor with memory and drivers for all components thereof in communication therewith, wherein
the multimedia processor is configured to record and play back a parent's message and a child's voice as speech and song on-demand and to display on the screen a parent's video and a recording of the child's eating habits; and
at least one eating and drinking utensil comprising a plurality of interactive handle buttons and electronic logic configured to talk wirelessly to the talking table set base per real time input from the child and the parent.

17. The interactive learning system for a child of claim 16, wherein the plurality of handle buttons on the table set base and the eating and drinking utensils comprise 3 control buttons corresponding to a first choice, a second choice and a third choice in that order from a top button, a middle button and a bottom button.

18. The interactive learning system for a child of claim 16, wherein the drinking utensil is a sippy cup comprising a pair of left and right handles wherein each handle includes a plurality of the handle buttons.

19. The interactive learning system for a child of claim 16, wherein the at least one eating utensil is a spork, a spoon and a fork configured to act as a joy stick in control of a multimedia visual and aural content.

20. The interactive learning system for a child of claim 16, wherein the talking table set base is configured substantially in the shape of a plate and a tray having a plurality of handholds and multiple separated food compartments.
